(19) United States
(12) Patent Application Publication
(10) Pub. No.: US 2004/0100453 A1
(43) Pub. Date: May 27, 2004

(54) Reading control device for four-line resistive touch panel

(75) Inventors: Show-Nan Chung, Taipei City (TW); Li-Hsin Lai, Taipei City (TW)

Correspondence Address: BACON & THOMAS, PLLC, 625 SLATERS LANE, FOURTH FLOOR, ALEXANDRIA, VA, 22314

(73) Assignee: Tatung Co., Ltd., Taipei City (TW)

(21) Appl. No.: 10/714,904

(22) Filed: Nov. 18, 2003

(30) Foreign Application Priority Data
Aug. 17, 2001 (TW) 90214138

(51) Int. Cl. G09G 5/00

(52) U.S. Cl. 345/173

(57) ABSTRACT

A reading control device for a four-line resistive touch panel including first and second conducting plates is disclosed. The device is electrically energized to alternately apply voltage to both the conducting plates so that a discharge is performed on the conducting plate not being electrically energized and an activation voltage is next read from the discharged conducting plate, thereby obtaining correct location data from the activation voltage. The sampling rate of the touch panel can be increased sufficiently for meeting the needs of a handwriting recognition system. Further, the larger the plate area is the higher the handwriting recognition accuracy will be.

### BACKGROUND OF THE INVENTION

1. Field of the Invention

The present invention relates to reading control device for a touch panel and, more particularly, to a reading control device for a four-line resistive touch panel having the capability of substantially removing stored energy from two conducting plates of the touch panel prior to correctly reading coordinate data therefrom.

2. Description of Related Art

Input devices of computer other than mouse and keyboard have been commercially available due to technological advancements. One of the input devices is touch panel comprising two conducting plates. Voltage, as controlled by a microprocessor, is alternately applied to the plates in which an activation voltage is read from one plate which is deactivated when voltage is not applied thereto at a very short period of time. Coordinate data can be obtained from the activation voltage. It is also known that charge will be stored between the plates when voltage is applied to either plate. Unfortunately, the stored charge will slow the activation voltage reading operation or even generate reading error. In this case, correct coordinate data can only be obtained by completely discharging the plate naturally. Inevitably, this will cause a time delay and reduce the sampling rate. This condition will deteriorate when the plates have a relatively large area. As a result, the purpose of increasing the sampling rate as required by handwriting recognition system is not achievable.

Therefore, it is desirable to provide a novel reading control device for a four-line resistive touch panel in order to mitigate and/or obviate the aforementioned problems.

### SUMMARY OF THE INVENTION

An object of the present invention is to provide a reading control device for a four-line resistive touch panel having the capabilities of substantially removing stored energy from two conducting plates thereof and increasing a sampling rate up to at least 300 times per second.

To achieve the above and other objects, the present invention provides a reading control device for a four-line resistive touch panel including first and second conducting plates wherein the reading control device is electrically energized to alternately apply voltage to both the first and second conducting plates so that a discharge is performed on the conducting plate not being electrically energized and an activation voltage is next read from the discharged conducting plate, thereby obtaining correct location data from the activation voltage. By utilizing the present invention, the sampling rate of the touch panel can be increased sufficiently for meeting the needs of a handwriting recognition system. Further, the larger the plate area is the higher the handwriting recognition accuracy will be.

Other objects, advantages, and novel features of the invention will become more apparent from the detailed description when taken in conjunction with the accompanying drawings.

### BRIEF DESCRIPTION OF THE DRAWINGS

FIG. 1 is a block diagram of the invention;

FIG. 2 is a detailed circuit representation of the reading control circuit 2 and the touch panel;

FIGS. 3A and 3B are flowcharts illustrating the X-coordinate and the Y-coordinate reading processes respectively;

FIG. 4A is a timing diagram of the reading process; and

FIG. 4B is a detailed timing diagram of the reading process measured between time t1 and t2.

### DETAILED DESCRIPTION OF THE PREFERRED EMBODIMENT

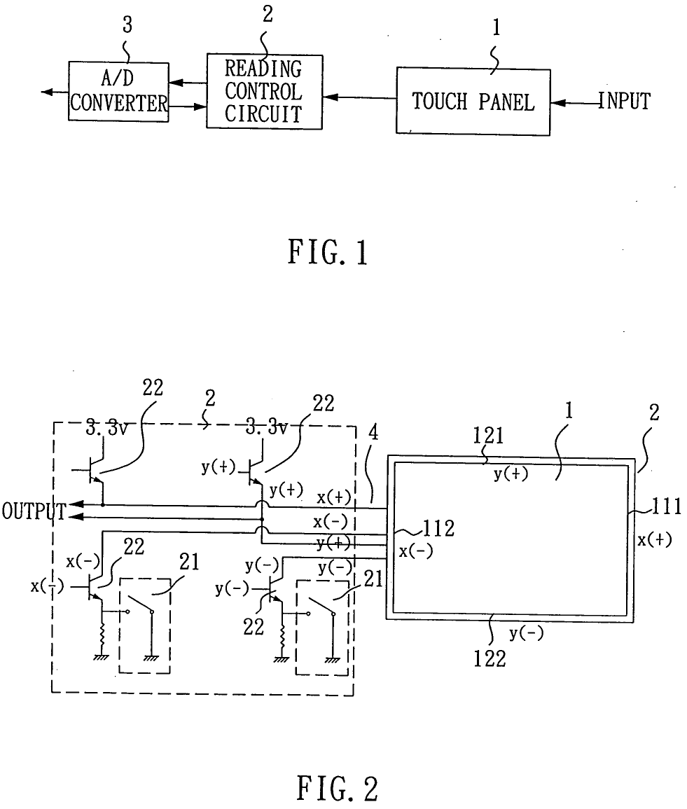

With reference to FIG. 1, there is shown a block diagram of a reading control device for a four-line resistive touch panel constructed in accordance with the invention. The device comprises a touch panel 1 disposed on a liquid crystal display (LCD), a reading control circuit 2 for receiving signals from the touch panel 1 via a bus, and an analog-to-digital (A/D) converter 3 for receiving analog signals from the reading control circuit 2 and converting the same into digital forms prior to transmitting to a CPU (central processing unit) of the device.

With reference to FIG. 2, the touch panel 1 comprises first and second rectangular (as shown) or square conducting plates and a resilient member made of dielectric insulating material. The first plate has edges of X(+)111 and X(−)112 and the second plate has edges of Y(+)121 and Y(−)122 respectively. The touch panel 1 is electrically coupled to the reading control circuit 2 via a bus 4. The bus 4 comprises four lines each electrically coupled to the corresponding one of four edges of the first and the second plates. The reading control circuit 2 comprises two ground circuits 21 for discharging and four switch transistors 22 in which two of the switch transistors 22 are electrically coupled to the ground circuits 21. Also, the switch transistor 22 is adapted to switch between discharge via the coupled ground circuit 21 and activation voltage reading, and the analog-to-digital converter 3 is provided to convert digital signal of converting system and analog signal of control circuit 2.

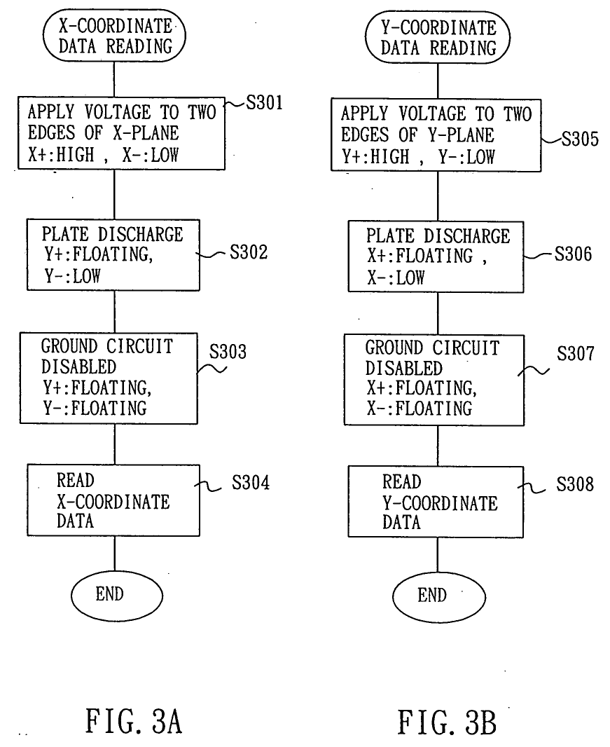

With reference to FIG. 3A, X-coordinate (i.e., the first plate) data reading process of the invention is illustrated below. The reading control circuit 2 will be enabled when the touch panel 1 is touched by a user or an object. Next, the reading control circuit 2 reads plane coordinate data via the bus 4 by performing steps of applying voltage to the first plate for causing the edge X(+)111 to go high and causing the edge X(−)112 to go low (step S301). Next, the switch transistor 22 corresponding to the edge X(−)112 is conducted to electrically couple to the associated ground circuit 21. At the same time, discharge is performed on the second plate for causing the edge Y(+)121 to go to float and causing the edge Y(−)122 to go to ground (step S302) wherein the discharge period of time is about 200 μs. Next, the switch transistor 22 is cut off and the associated ground circuit 21 is disabled for causing both the edges Y(+)121 and Y(−)122 to go to float (step S303). Activation voltage will be read from the edge Y(+)121 of the second plate via the bus 4 for obtaining coordinate data of the first plate after the voltage of the reading control circuit 2 has been stable (step S304). The reading process ends normally prior to switching to read Y-coordinate data.

With reference to FIG. 3B, Y-coordinate (i.e., the second plate) data reading process of the invention is illustrated below. The reading control circuit 2 reads plane coordinate data of the second plate via the bus 4 by performing steps of applying voltage to two edges of the second plate for causing the edge Y(+)121 to go high and causing the edge Y(−)122 to go low (step S305). Next, the switch transistor 22 corresponding to the edge Y(−)122 is conducted to electrically couple to the associated ground circuit 21. At the same time, discharge is performed on the first plate for causing the edge X(+)111 to go to float and causing the edge Y(−)122 to go to ground (step S306) in which the discharge period of time is about 200 μs. Next, the switch transistor 22 is cut off and the associated ground circuit 21 is disabled (step S307). Activation voltage will be read from the edge X(+)111 of the first plate via the bus 4 for obtaining coordinate data of the second plate after the voltage of the reading control circuit 2 has been stable (step S308). The reading process ends normally prior to switching to read X-coordinate data. In brief, the coordinate data reading processes of X-coordinate and Y-coordinate will be performed alternately by applying voltage to both plates alternately in which a discharge via a ground circuit is performed on the plate not being electrically energized and an activation voltage is next read from the discharged plate. As an end, correct data about the location of the touch panel touched by a user or an object can be obtained.

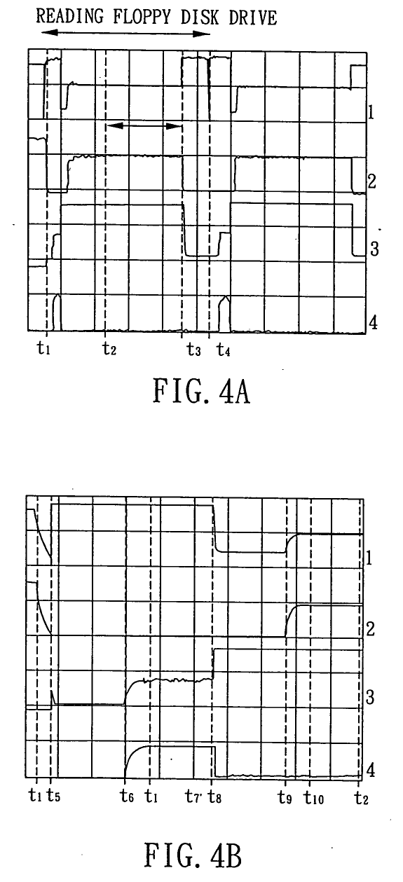

With reference to FIG. 4A, a timing diagram of the coordinate data reading process is depicted. There are four waveforms in the graph in which a first waveform is a representation of signal measured in the edge X(+)111, a second waveform is a representation of signal measured in the edge X(−)112, a third waveform is a representation of signal measured in the edge Y(+)121, and a fourth waveform is a representation of signal measured in the edge X(−)122 respectively. The edge X(+)111 is negatively triggered at time t1 for reading coordinate data. The read coordinate data is then sent out at the period of time from t2 to t3. Wait period of time is from t3 to t4 in which discharge and initialization are performed in this time span. A period of time from t1 to t4 is about 5.1 ms.

FIG. 4B is a detailed timing diagram of the reading process measured between t1 and t2. The reading control circuit 2 reads coordinate data of the first plate (i.e., X-plane). Period of time from t5 to t6 is a discharge period lasted for about 200 μs in which voltage is applied to X-plane for causing the edge X(+)111 to go to high, the edge X(−)112 to go to low, the edge Y(+)121 to go to float, and the edge Y(−)122 to go to ground (i.e., discharged) respectively. Period of time from t6 to t7 is a ready period in which stored energy is removed (i.e., discharged), ground circuit 21 is disabled, and both the edges Y(+)121 and Y(−)122 go to float. Next, read coordinate data of X-plane at the time span from t7 to t7′ about 100 μs after the voltage has been stable. Next switch to read coordinate data of Y-plane. Period of time from t8 to t9 is a discharge period lasted for about 200 μs. That is, voltage is applied to Y-plane for causing the edge Y(+)121 to go to high, the edge Y(−)122 to go to low, the edge X(+)111 to go to float, and the edge X(−)112 to go to ground (i.e., discharged) respectively. Period of time from t9 to t10 is a ready period in which stored energy is removed (i.e., discharged), ground circuit 21 is disabled, and both the edges X(+)111 and X(−)112 go to float. Next, read coordinate data of Y-plane at the time span from t10 to t2. The above two processes for reading coordinate data of X-plane and Y-plane are performed alternately.

The invention can increase the sampling rate of touch panel for meeting the needs of a handwriting recognition system. Further, the larger the plate area is the higher the handwriting recognition accuracy will be.

Although the present invention has been explained in relation to its preferred embodiment, it is to be understood that many other possible modifications and variations can be made without departing from the spirit and scope of the invention as hereinafter claimed.

What is claimed is:

1. A reading control device for a four-line resistive touch panel including first and second conducting plates wherein the reading control device is electrically energized to alternately apply voltage to both the first and second conducting plates so that a discharge is performed on the conducting plate not being electrically energized and an activation voltage is next read from the discharged conducting plate, thereby obtaining correct location data from the activation voltage.

2. The reading control device as claimed in claim 1, further comprising a resilient member made of dielectric insulating material between the first and second conducting plates.

3. The reading control device as claimed in claim 1, wherein the first conducting plate comprises two edges of X(+) and X(−) and the second conducting plate comprises two edges of Y(+) and Y(−) respectively.

4. The reading control device as claimed in claim 1, further comprising a bus including four lines each electrically coupled to one of the edges X(+), X(−), Y(+), and Y(−).

5. The reading control device as claimed in claim 1, further comprising a reading control circuit including two ground circuits for discharging.

6. The reading control device as claimed in claim 5, wherein the reading control circuit further includes a plurality of switch transistors, two of the switch transistors being operative to couple to the ground circuits so that each switch transistor associated with the ground circuit is adapted to switch between the discharge via the coupled ground circuit or the activation voltage reading.

7. The reading control device as claimed in claim 4, wherein voltage is alternately applied to each edge of the first and second conducting plates via the corresponding line of the bus so as to conduct the corresponding switch transistor for discharging the conducting plate not being electrically energized via the coupled ground circuit and read the activation voltage from the discharged conducting plate, thereby obtaining correct location data from the activation voltage.

8. The reading control device as claimed in claim 5, wherein voltage is alternately applied to each edge of the first and second conducting plates via the corresponding line of the bus so as to conduct the corresponding switch transistor for discharging the conducting plate not being electrically energized via the coupled ground circuit and read the activation voltage from the discharged conducting plate, thereby obtaining correct location data from the activation voltage.

9. The reading control device as claimed in claim 6, wherein voltage is alternately applied to each edge of the first and second conducting plates via the corresponding line of the bus so as to conduct the corresponding switch transistor for discharging the conducting plate not being electrically energized via the coupled ground circuit and read the activation voltage from the discharged conducting plate, thereby obtaining correct location data from the activation voltage.
